(19) United States
(12) Patent Application Publication
(10) Pub. No.: US 2006/0253305 A1
(43) Pub. Date: Nov. 9, 2006

(54) Computerized automated new policy quoting system and method

(76) Inventor: Jack B. Dougherty, Clearwater, FL (US)

Correspondence Address: Jack B. Dougherty, 1901 Ulmerton Road, Clearwater, FL, 33762-2309, US

(21) Appl. No.: 11/123,134

(22) Filed: May 6, 2005

(51) Int. Cl. G06Q 40/00

(52) U.S. Cl. 705/4

(57) ABSTRACT

An automated computerized system for quoting new insurance policies or other policies through a method utilizing public data searches, information provided by consumer reporting agencies, and other information to quote individuals new insurance policies without the need for the individual to call in and/or come in to an office to give the pertinent needed quoting information.

### FIELD OF THE INVENTION

This invention relates generally to computerized systems, and more particularly to a computerized/automated system for automatic quoting of large quantities of target risks by utilizing public data information as well as data from consumer reporting agencies to pull and blend all information together to produce a finished, professional, firm quote without the need for a customer risk to call into a company or agency/broker for the finished quote. The invention also relates to a system for the collection, processing and dissemination of the information gathered once the information is obtained from the consumer reporting agencies and/or public data information sources.

### BACKGROUND OF INVENTION

It is readily apparent there are numerous companies, both insurance and others that are spending considerable amounts of money on advertising through television, radio, newspaper and other methods to solicit new customers to call in for insurance price quotes. Often customers are reluctant to call in due to the perceived time involved in giving information and the perception of generally not obtaining a lower insurance rate quote than the rate they are currently paying with their current carrier or company. Due to the reluctance of individuals to call to give this information many consumers are paying considerably more for insurance premiums and other premiums than they would if they received a firm quote and could compare exactly what they were paying currently under their present carrier/company with what they would be paying under the new carrier/company.

### BRIEF SUMMARY OF INVENTION

The present invention is an automated computerized system for giving firm insurance quotes by obtaining pertinent public data information and information from consumer reporting agencies as well as other sources of information. Once the information is obtained on the target household, the information is merged into quoting or rating software which will then automatically rate the target risk given the information which has been pulled and blended together from the consumer reporting, public data records and other sources. This firm insurance quote is then extracted from the quoting software and merged into a letter and/or quote format so that a firm or semi firm quote can be mailed to large numbers of potential new policyholders.

The information sent to the new target policyholder must be in such a format that will be attractive to the potential policyholder to open and read through completely, this may include special incentives such as a giveaway inside that can be activated to provide an incentive for the consumer to read through and accept or reject the quote.

### BRIEF DESCRIPTION OF THE DRAWINGS

FIG. 1 Drawing of Sample New Policy Quote Letter

FIG. 2 Drawing of Sample New Policy Quote Form

FIG. 3 Drawing of Sample Excel Quoting Spreadsheet

FIG. 4 Drawing of Sample CLUE Report

FIG. 5 Drawing of Sample Motor Vehicle Record

FIG. 6 Drawing of Sample Additional Driver Discovery Information

FIG. 7 Drawing of Sample Driver License Search

FIG. 8 Drawing of Sample Insurance Carrier Information (Probable Carrier Information)

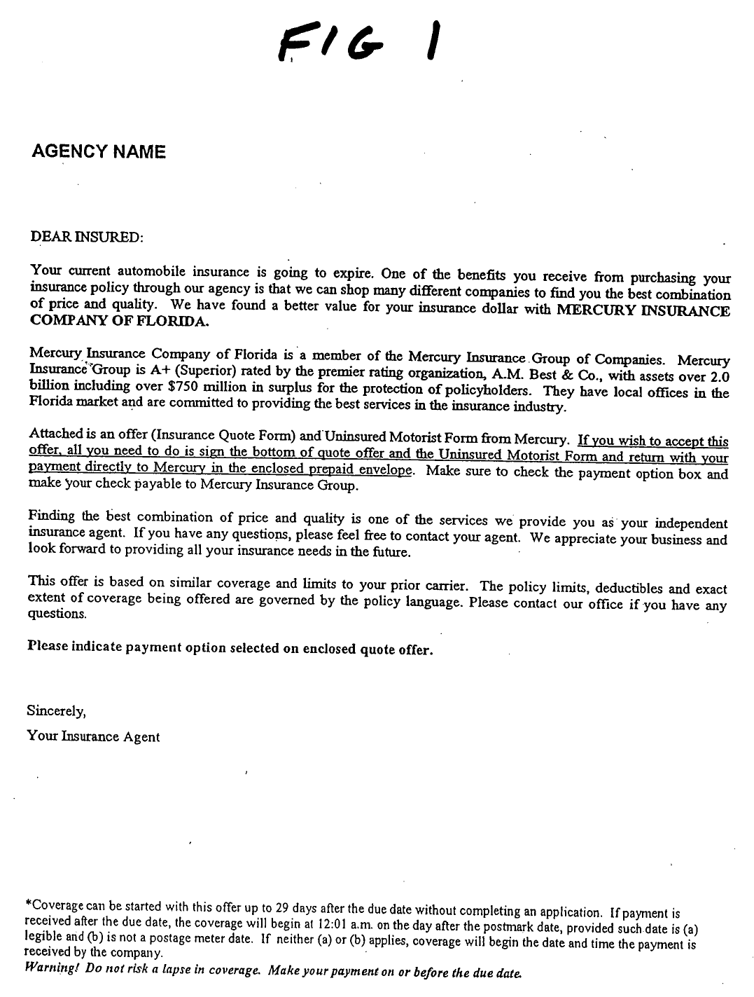

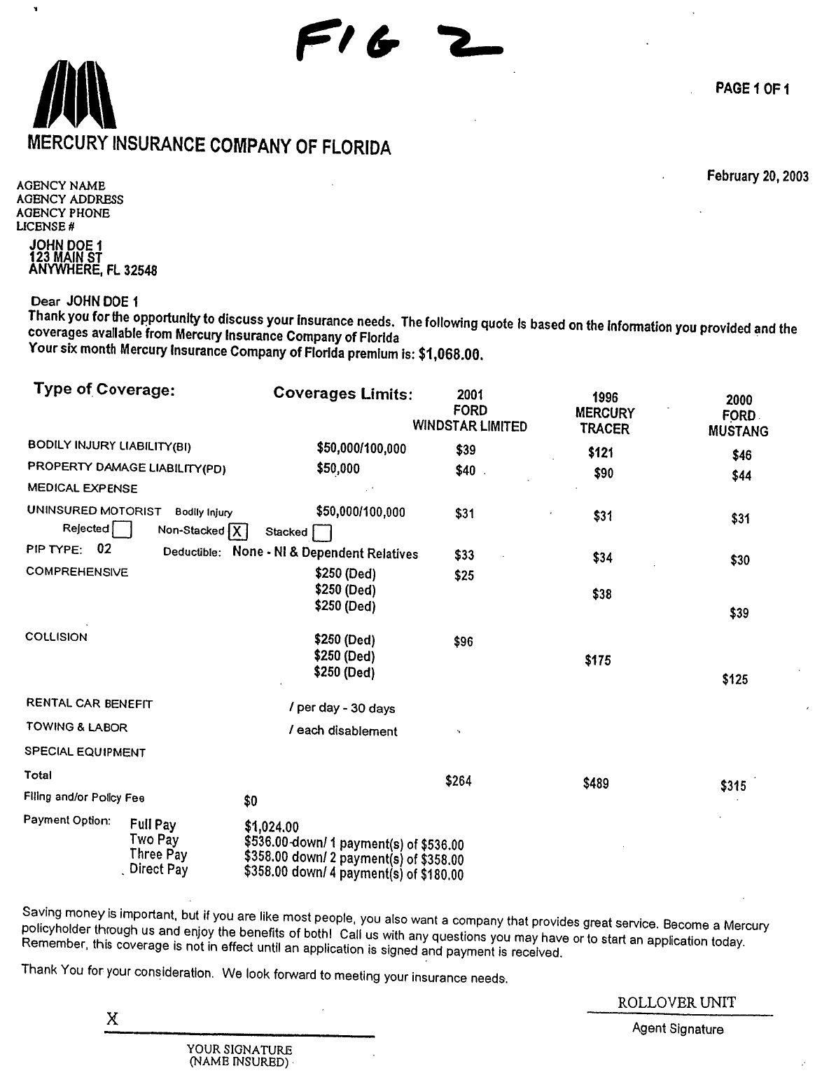

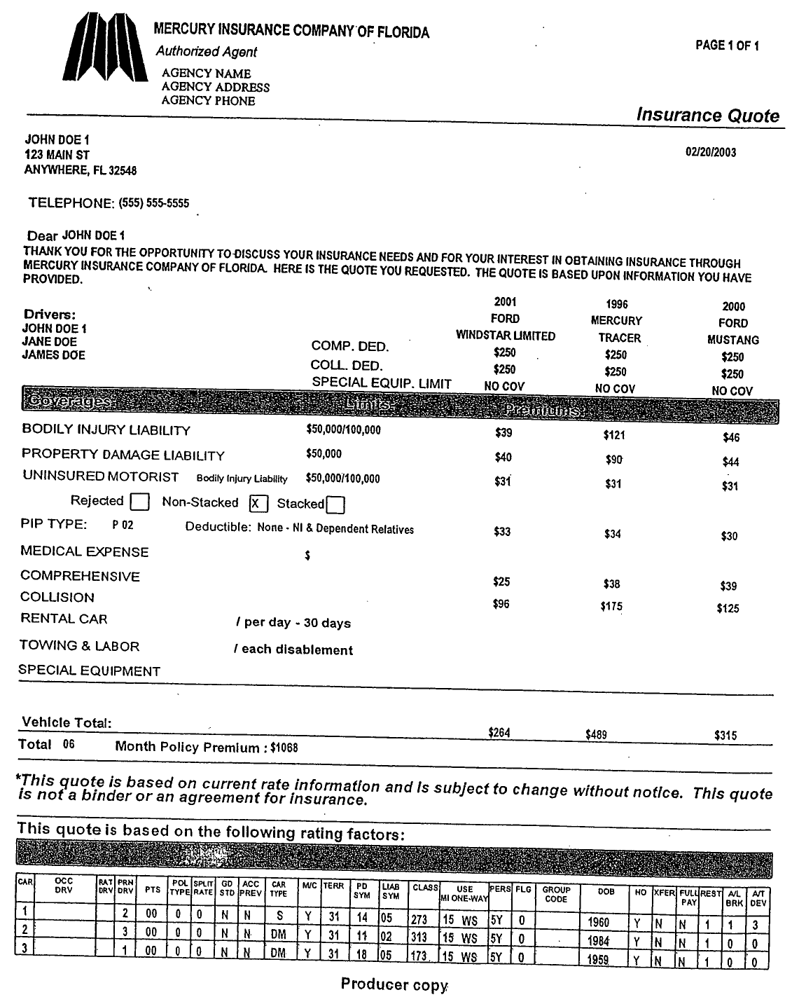

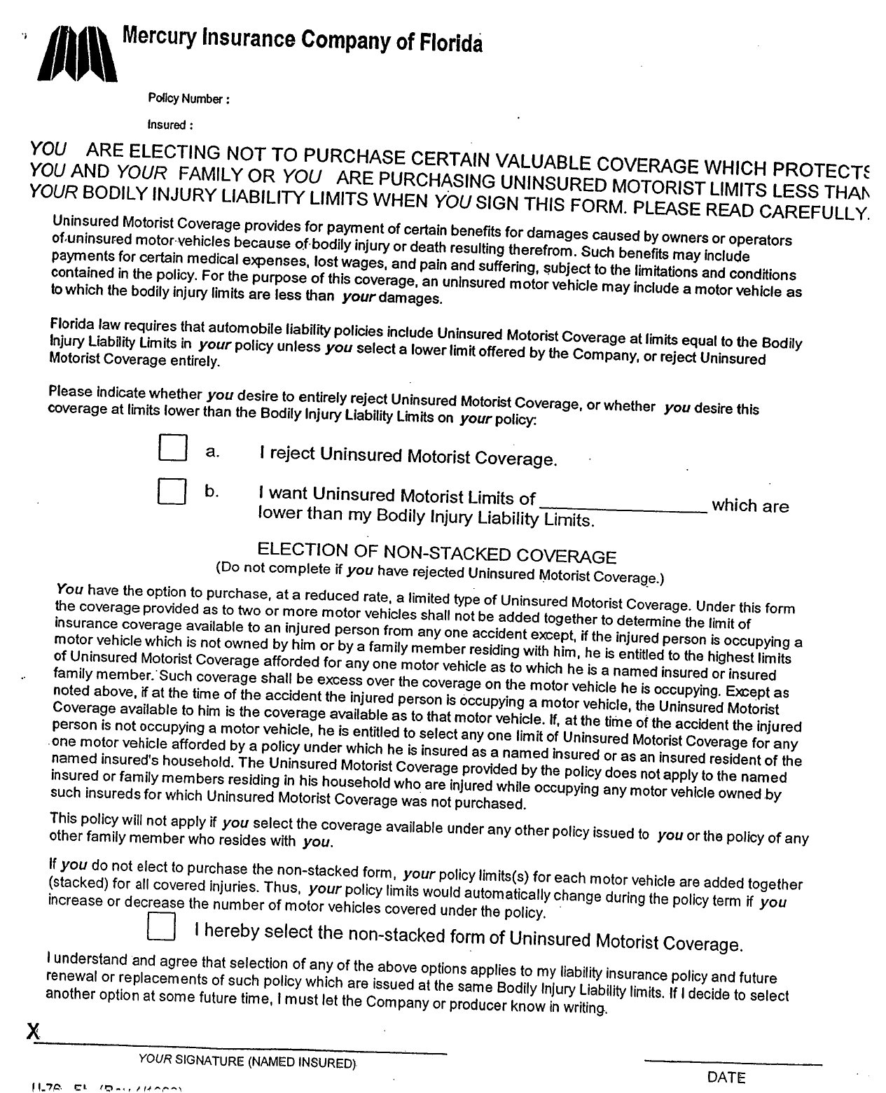

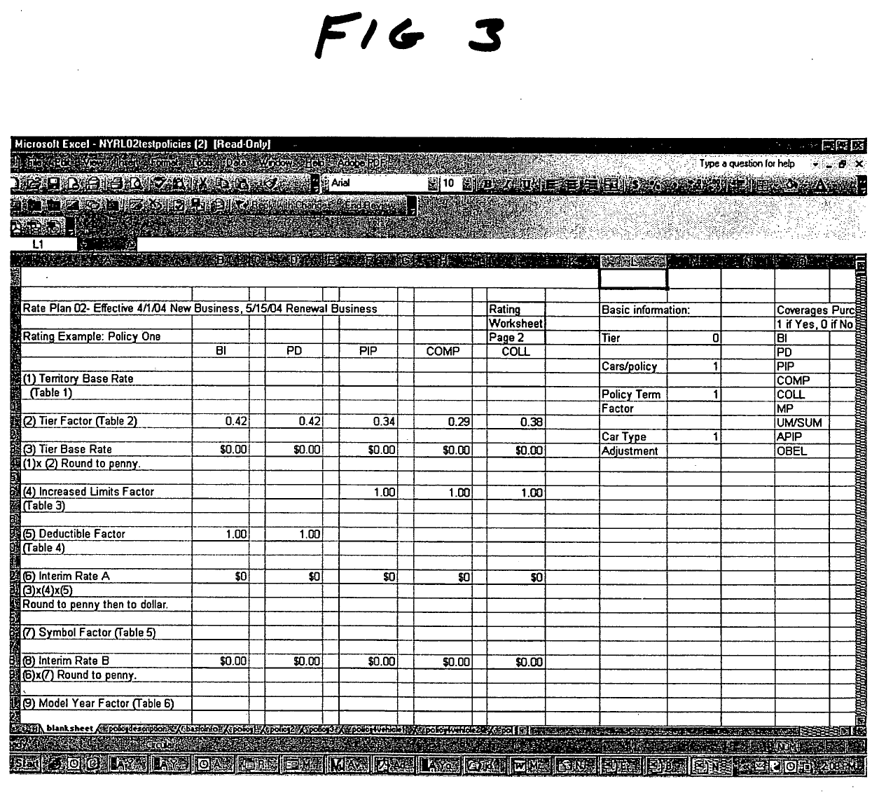

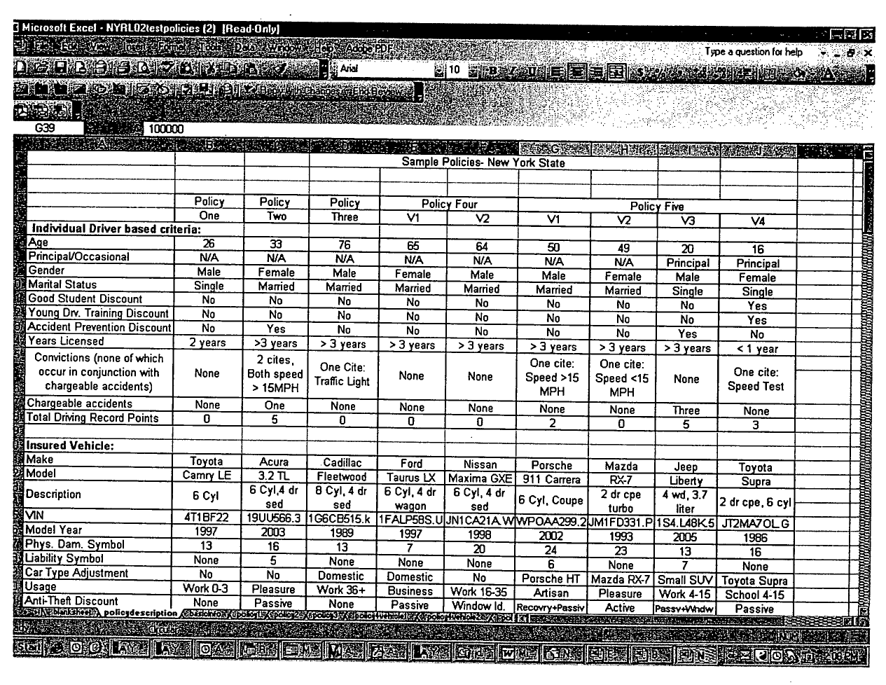

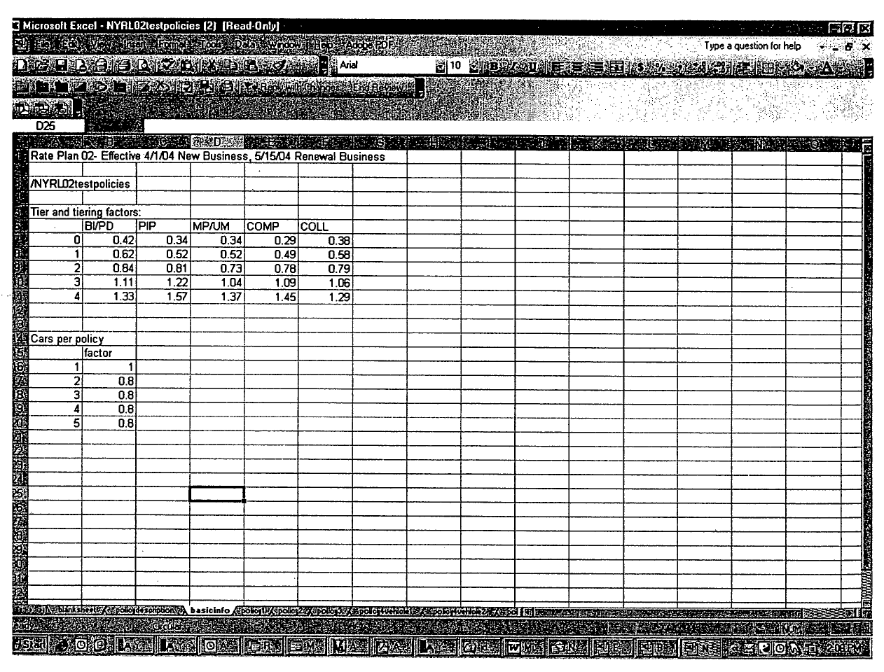

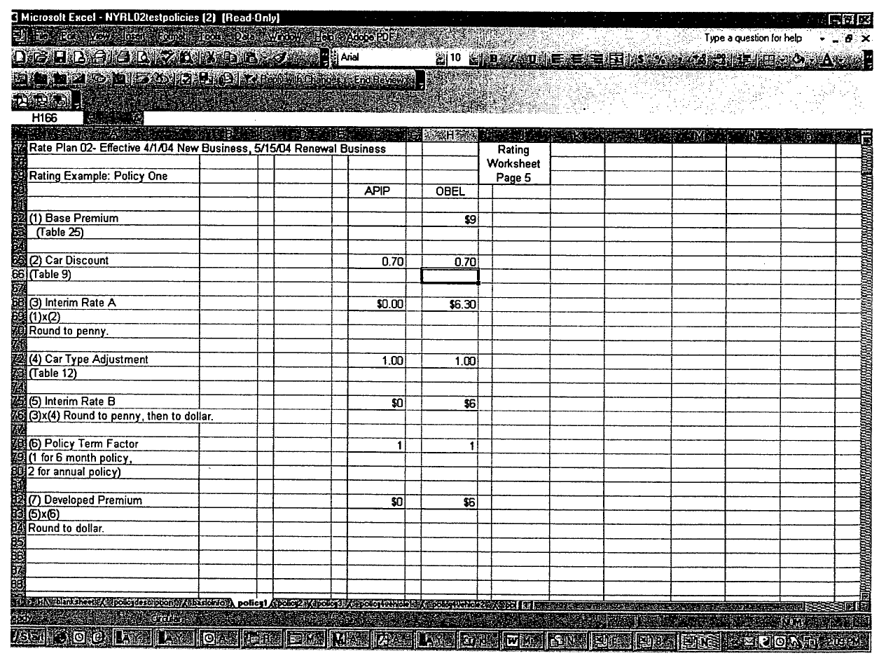

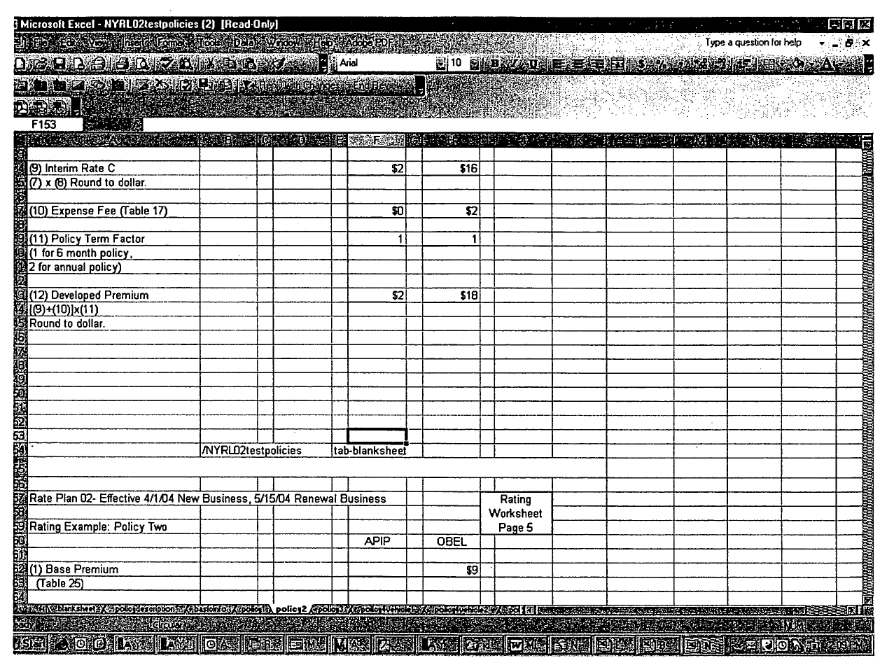

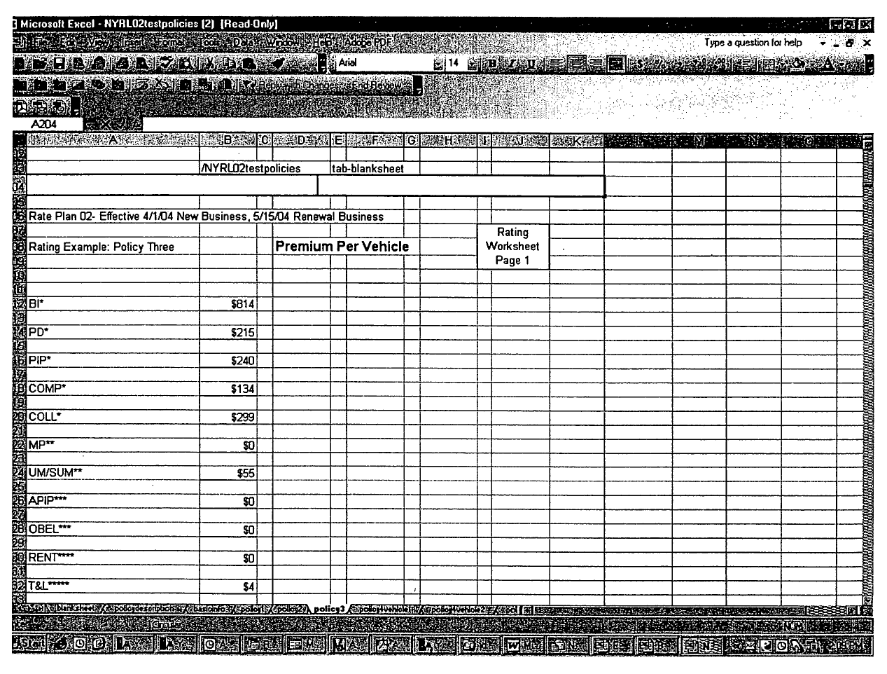

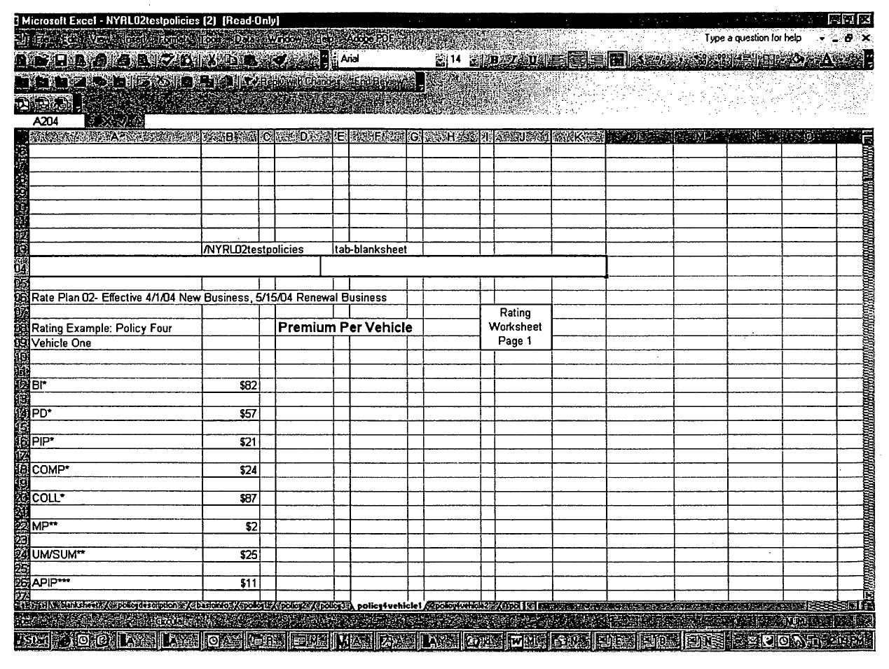

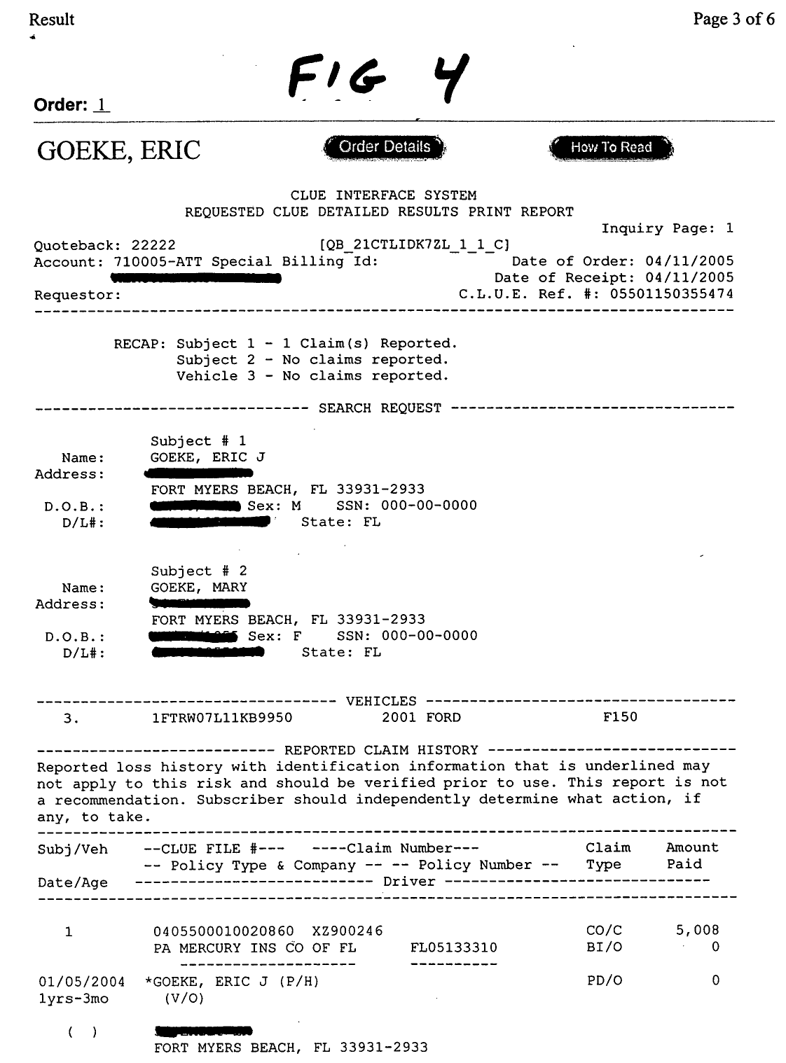

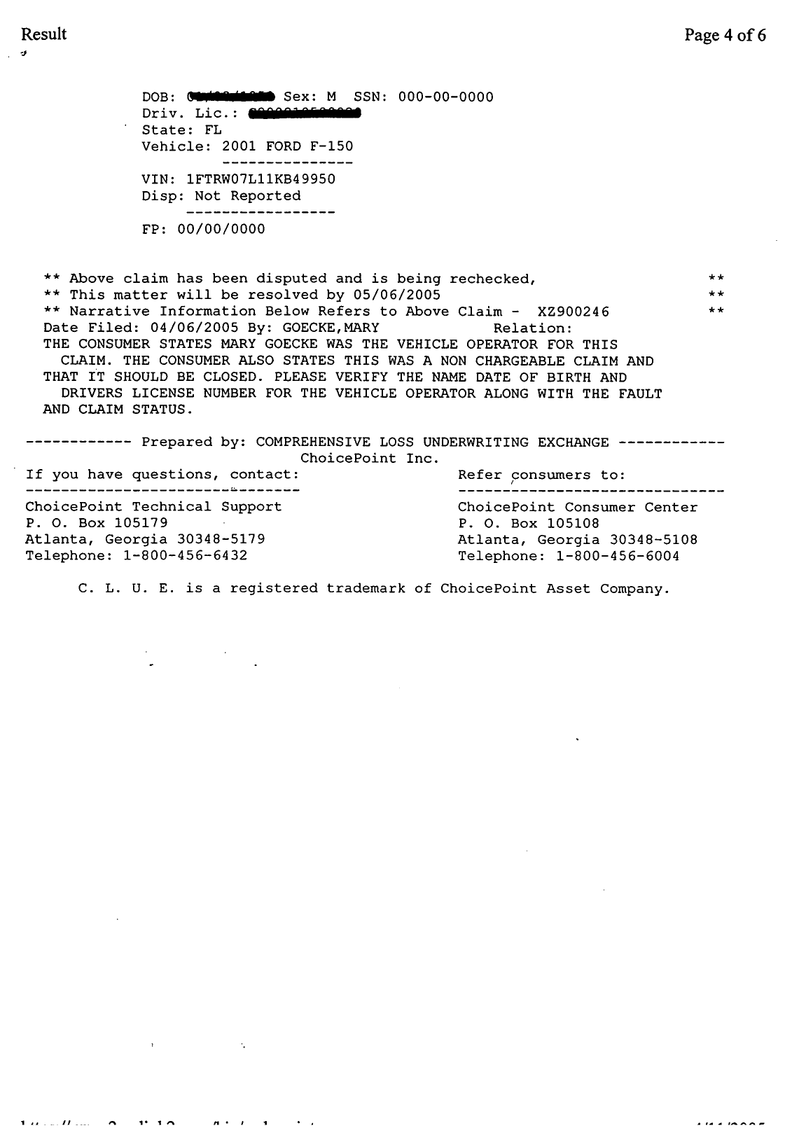

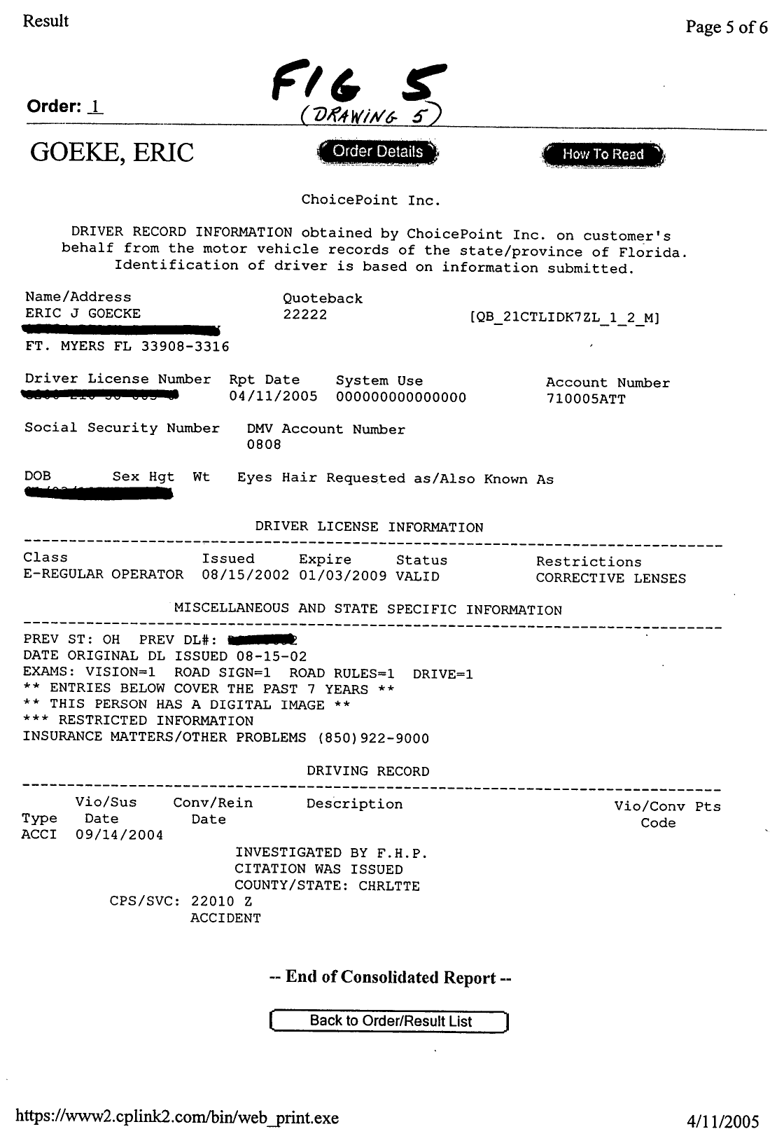

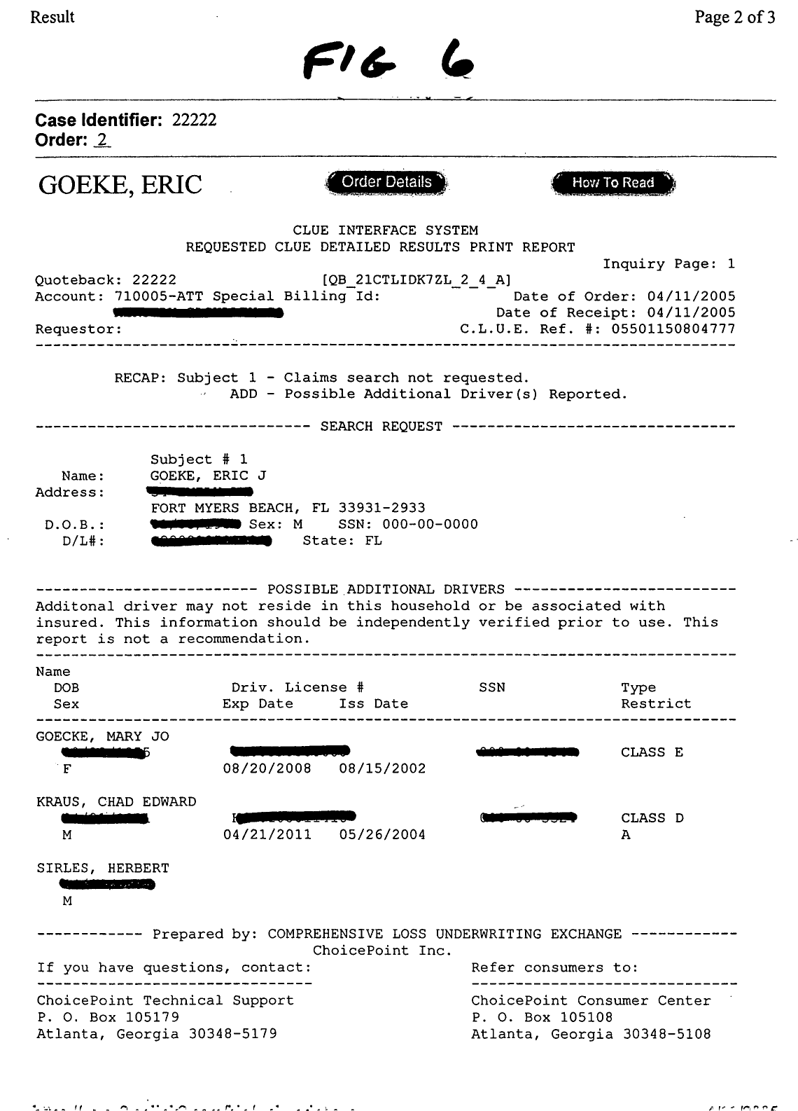

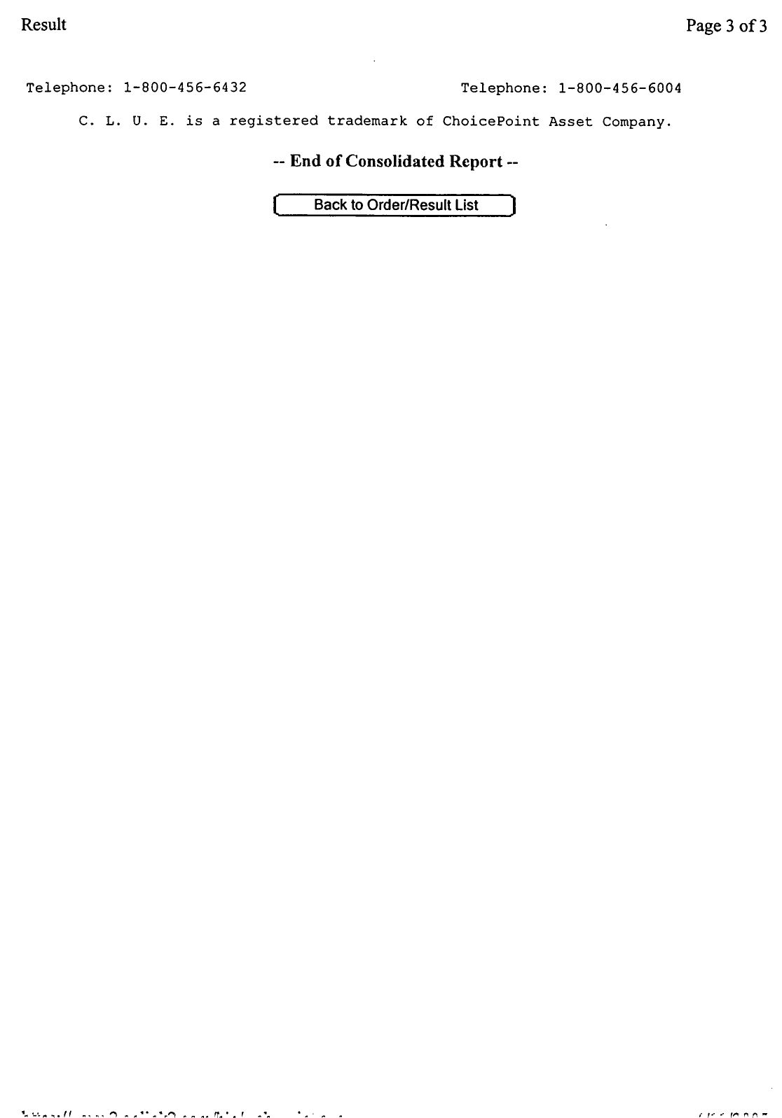

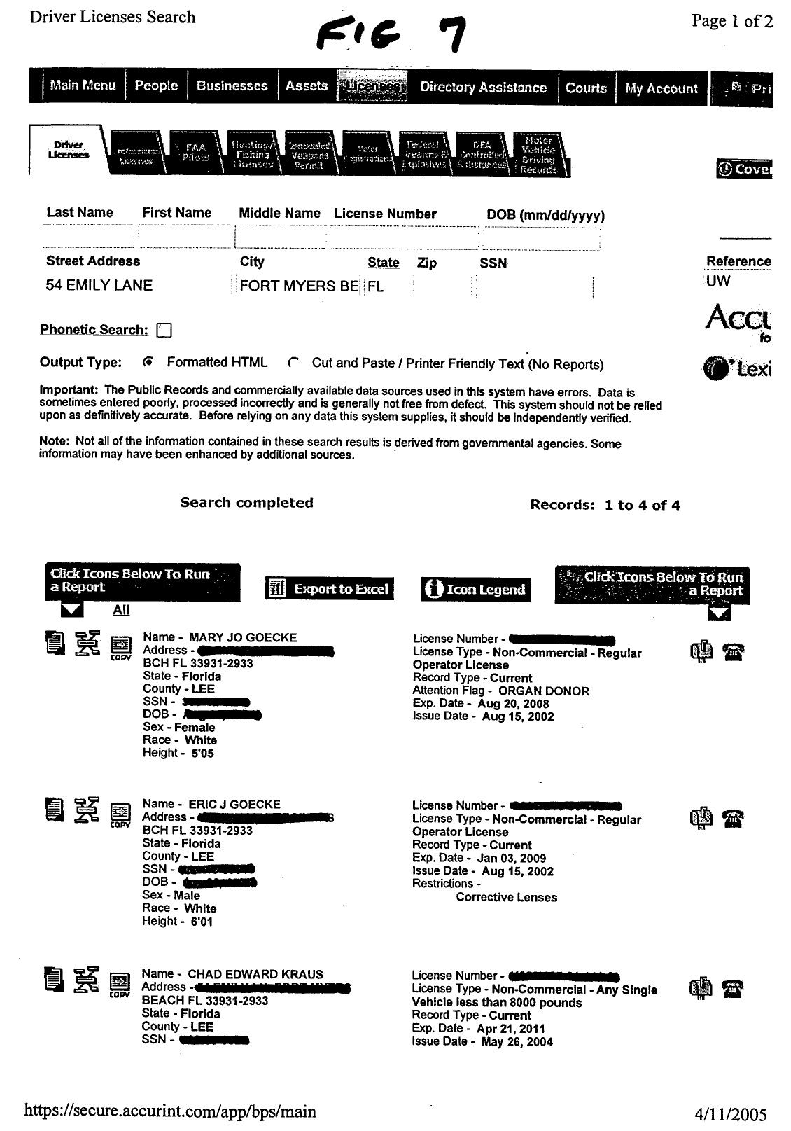

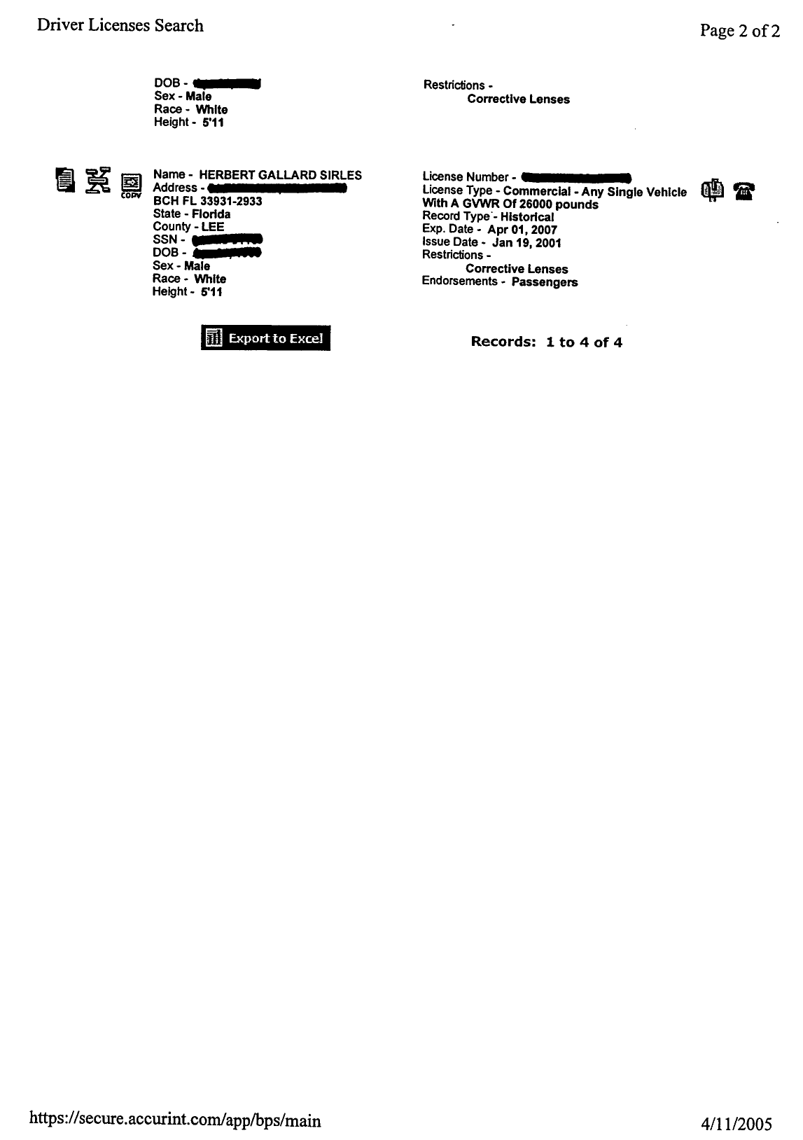

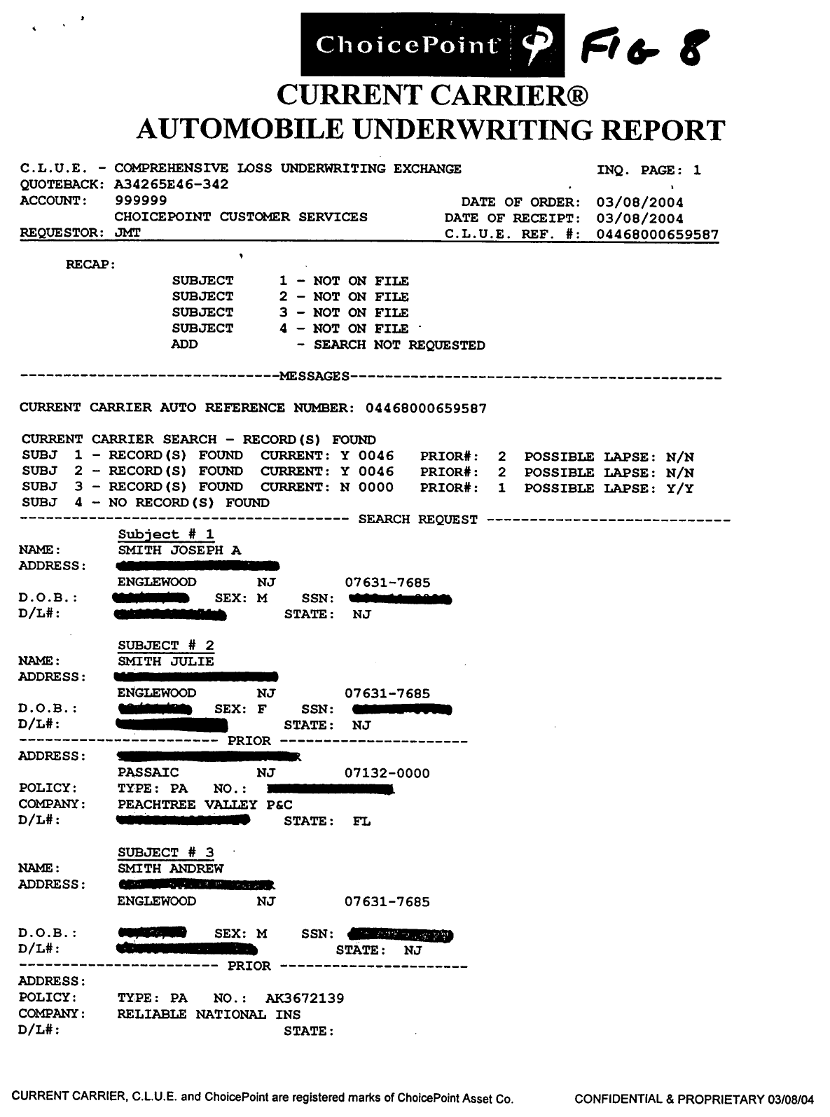

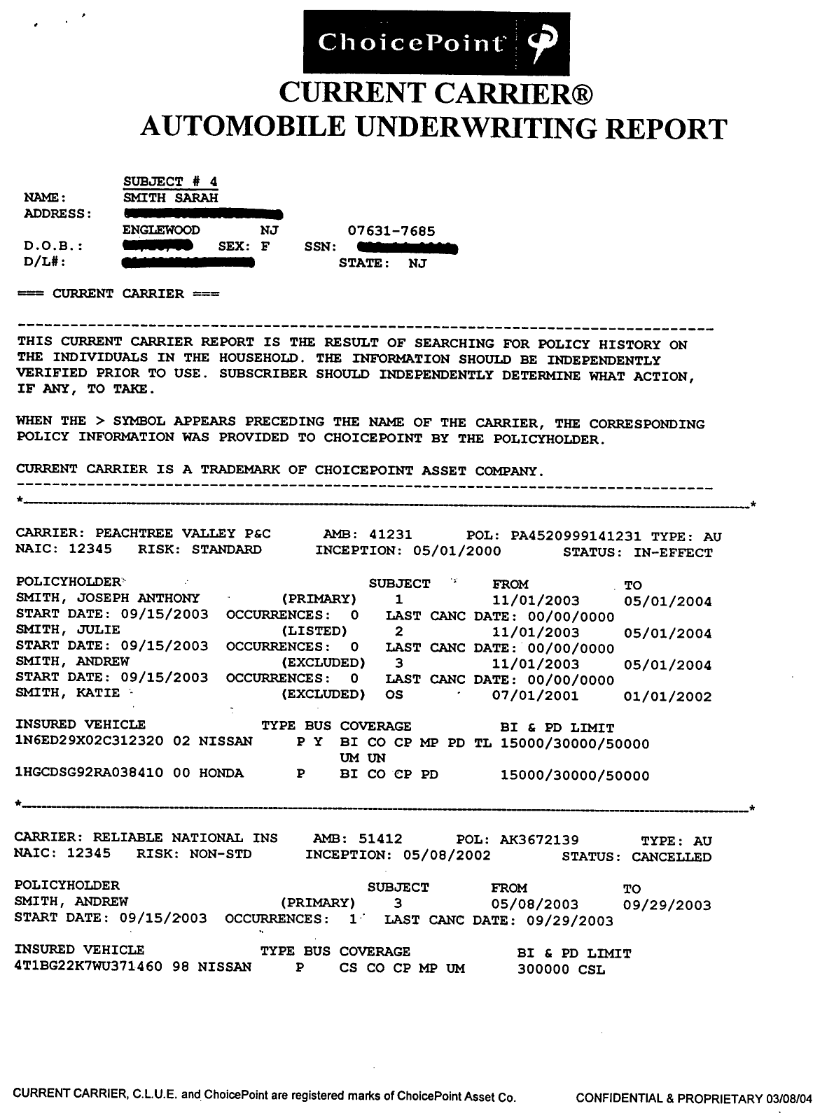

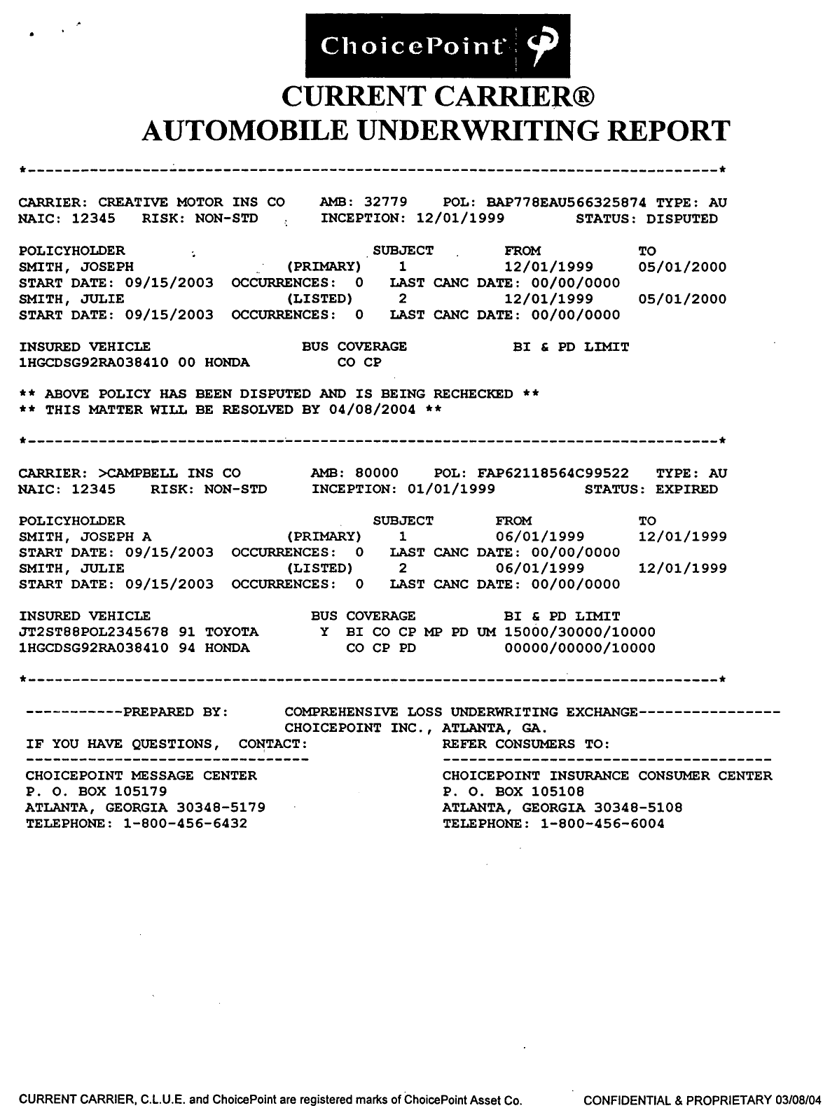

### DETAILED DESCRIPTION OF INVENTION

The invention is a computerized automated system for pulling large quantities of data available from public records, consumer reporting agencies and other sources into one useable format to allow vast numbers of automated quotes to multiple potential target risks. The information from the public record data searches is stored in a format similar to an excel spreadsheet or other storage database. This information is then electronically matched with data from consumer reporting agencies as well as data available from other sources to give sufficient information required to obtain a firm or semi firm insurance price quote. The information that has been obtained is extracted from the compiled database and is then placed in quoting software. The quoting/rating software/system rates and quotes the target policyholders. Once the target policy holders are quoted, the quoted rate along with the exact quoting information is exported into merged documents and formats which can then print the required letter and abbreviated insurance application for the target risk to receive, review and compare to their current insurance carrier's price. The quoted output can be varied based on the marketing requirements of the insurance carrier or any other company to produce the output that works best for the conversion of new policies.

Once the quote is reviewed, analyzed, and accepted, it is signed by the target risk and sent back to the insurance company or agent/broker along with the down payment for the new policy. This procedure can vary based on marketing requirements of the procedures that produce the best conversion.

The policy is then issued by the insurance carrier and a complete declaration page, policy jacket, required forms, etc. are mailed to the new policyholder by the insurance company or agent/broker.

What we claim is:

1. A computerized/automated executable method to obtain pertinent quoting information from public record searches and data provided by consumer reporting agencies. The method when executed comprises:
a. Receiving a plurality of information from public records, consumer reporting agencies databases, and other sources consisting of information to infer or to directly or indirectly determine among other things:
i. vehicle registrations at target addresses.
ii. drivers license information listing drivers registered at the target addresses.
iii. motor vehicle records of the drivers listed at the target address as determined by the driver's license information above.
iv. Clue, A+ Reports, or other reports from consumer reporting agencies or other sources listing prior insurance claims information.
v. information on additional drivers in the household using additional driver discovery services and sources from consumer reporting agencies or public records.
vi. prior insurance carrier information using data from consumer reporting agencies including information on prior insurance carriers and prior liability limits when available.
vii. proxy information for financial stability.
b. A method of receiving information on the last time a motor vehicle record or other type of consumer report was run giving indication of the approximate expiration date of the target risk's current insurance policy; or, in the absence of that information, other timing information gleaned from records.
c. A method of analyzing partial or incomplete information from different data sources or consumer reporting agencies as proxies to determine enough information for use in generating a firm quote even if exact information is not available.

2. An abbreviated application that would be included with the new policy quote. The abbreviated application would be in such a format that it would be easy to read, understand, and easy to accept. The abbreviated application would be significantly shorter and easier to complete than the standard application used. The abbreviated application can change from the drawing based on the marketing decisions of formats/styles that will increase new policy acceptance.

3. A merge function for the above data which would pull all of the information obtained into a spreadsheet or other format capable of being used with various rating software/systems to automatically rate large bits of information.

4. An extraction method to pull information from the rating software/system once the rate has been determined to transfer that information for use in the final marketing product.

5. A simplified letter to send with the quote to interest the target risk in accepting the quote and obtaining a new policy.

6. The critical aspects of the mailing must then get the target to open the envelope and read through the information. An incentive to read through the data could be included.

7. An option will be available for the customer to call to change or add coverage or rating information if they so desire.
